(19) United States
(12) Patent Application Publication
(10) Pub. No.: US 2002/0087875 A1
(43) Pub. Date: Jul. 4, 2002

(54) Method and system for calling line authentication

(76) Inventor: Thomas Lee Adams, Austin, TX (US)

Correspondence Address: Joseph F. Hetz, Brinks Hofer Gilson & Lione, P.O. Box 10395, Chicago, IL, 60610, US

(21) Appl. No.: 09/747,741

(22) Filed: Dec. 22, 2000

(51) Int. Cl. H04L 9/32

(52) U.S. Cl. 713/200

(57) ABSTRACT

A calling line authentication system and method are disclosed. The system comprises a communication network and a key server. The communication network receives a telephone number signal from a calling source attempting to access a secured service of a calling destination. The communication network identifies a directory number representative of the calling source and provides an authentication key to the key server when the directory number is one of a list of authorized directory numbers stored within the communication network. The key server provides the authentication key to the calling destination as an indication that the calling source has authorization for access to the secured service.

### BACKGROUND OF THE INVENTION

1. Field Of The Invention

The present invention generally relates to computer networks, and more particularly relates to calling line authentication within an Internet environment.

2. Description Of The Related Art

An illustration of some basic components of an Advanced Intelligent Network (AIN) within a communication network in the form of a public switched telephone network 10 (PSTN 10) is shown in FIG. 1. Referring to FIG. 1, Service Switching Points (SSPs) 11a-11b are connected with a Signaling Transfer Point 12 and a Service Control Point (SCP) 13 by a Common Channel Signaling network 15. A subscriber line 17a connects an Internet server 20 to the SSP 11a. Subscriber lines 17b-18d connect client workstations 30a-30c to the SSP l lb. Subscriber lines 17e-17f connect client workstations 30d-30f to the SSP 11c. The SSPs 11a- 11b are interconnected by trunks 16a and 16b to enable client workstations 30a-30f to establish communication links with the Internet server 20.

The Internet server 20 provides Internet services for users of client workstations 30a-30f. For access to secure services, it is sometimes necessary that the Internet server 20 have the capability to differentiate an authorized user of client workstations 30a-30f from an unauthorized user of client workstations 30a-30f.

One known authentication method involves having a user of client workstations 30a-30f input a user identification, a personal password, and an e-mail address. In response, the Internet server 20 provides an e-mail having a key for granting access to the secure services to the user. While the objective of this method is to enable the Internet server 20 to differentiate an authorized user from an unauthorized user, the Internet server 20 does not have the capability to ascertain when an unauthorized user has obtained the user identification, the personal password, and the e-mail address of an authorized user.

Preventing an unauthorized user from gaining access to the client workstations 30a-30f is more feasible and reliable than attempting to prevent an unauthorized user from obtaining the user identification, the personal password, and the e-mail address of an authorized user. Accordingly, an authentication method for an Internet server 20 predicated upon preventing an unauthorized user from gaining access to the client workstations 30a-30f is desirable.

### BRIEF DESCRIPTION OF THE DRAWINGS

FIG. 1 is a diagram illustrating a prior art computer network including an Advanced Intelligent Network (AIN) system.

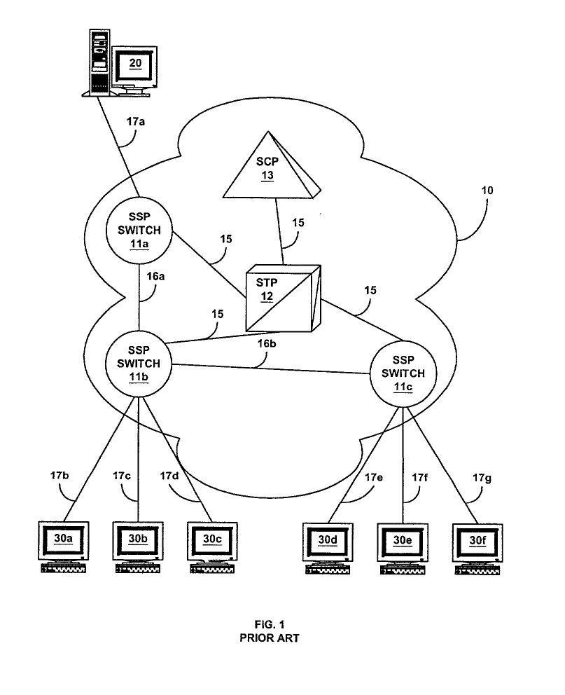

FIG. 2 is a diagram illustrating of an exemplary computer network system in accordance with an embodiment of the present invention.

FIG. 3 is a flow chart of a key distribution routine in accordance with another embodiment of the present invention.

### DETAILED DESCRIPTION OF THE PRESENTLY PREFERRED EMBODIMENT(S)

It is an advantage of the invention to provide method and system for restricting access to secured services provided by a dial-up server.

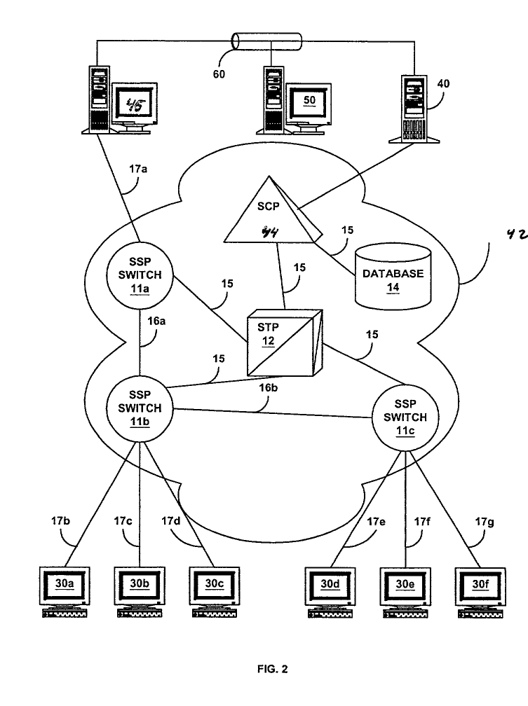

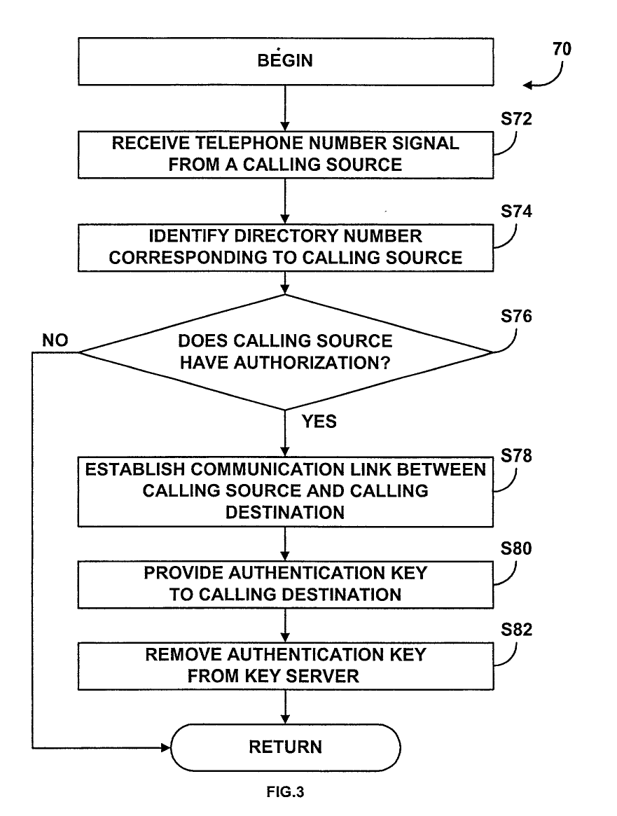

Referring to FIGS. 2 and 3, SSPs 11a-11c, an SCP 44, a database 14, a firewall 40, a key server 50, and an ethernet 60 collectively comprise one embodiment of a calling line authentication system in accordance with the present invention for implementing a key distribution routine 70 in accordance with the present invention. An exemplary implementation of routine 70 involving client workstation 30a will now be described herein in conjunction with client workstations 30a-30c being authorized calling sources for a secured service of Internet server 45.

During a stage S72 of routine 70, SSP 11b receives a telephone number signal representative of Internet server from client workstation 30a. In one embodiment, the telephone number signal can be an 800 toll free number assigned to Internet server 45. In response, SSP 11b conventionally provides a termination attempt trigger (TAT) to SSP 11a upon receipt of the telephone number signal during a stage S74 of routine 70. The TAT identifies a directory number representative of client workstation 30a, and is therefore an indication to SSP 11a that client workstation 30a wishes to establish a communication link with Internet server 45. In response to the TAT, SSP 11a provides a query to SCP 44 that includes an authorization for establishing the communication link between client workstation 30a and Internet server 45.

Database 14 of the telephone network 42 stores a list of directory numbers having authorization to access the secured service on Internet server 45, and a corresponding plurality of authentication keys for granting access to the secured service on Internet server 45. In response to the query, SCP 44 searches the list of authorized directory numbers in database 14 for the directory number of client workstation 30a during a stage S76 of routine 70. Upon detection of the directory number, SCP 44 retrieves one of the authentication keys from database 14.

During a stage S78 of routine 70, SCP 44 conventionally directs SSP 11a and SSP 11b to establish the communication link between client workstation 30a and Internet server 45.

During a stage S80 of routine 70, SCP 44 provides the retrieved authentication key to key server 50 via firewall 40 and ethernet 60. Key server 50 in turn provides the retrieved authentication key to Internet server 45. In one embodiment, Internet server 45 queries key server 50 for the authentication key upon an establishment of the communication link between client workstation 30a and Internet server 45. In another embodiment, key server 50 provides the authentication key to Internet server 45 upon a detection of the establishment of the communication link between client workstation 30a and Internet server 45. During a stage S82 of routine 70, key SCP 44 removes the retrieved authentication key from key server 50.

An exemplary implementation of routine 70 involving client workstation 30d will now be described herein in conjunction with client workstations 30a-30c being unauthorized calling sources for secured services of Internet server 45, and client workstations 30d-30f being unauthorized calling sources for secured services of Internet server 45.

During stage S72 of routine 70, SSP 11c receives a telephone number signal representative of Internet server 45 from client workstation 30d. In response, SSP 11c conventionally provides a termination attempt trigger (TAT) to SSP 11a upon receipt of the telephone number signal during stage S74 of routine 70. The TAT identifies a directory number representative of client workstation 30d, and is therefore an indication to SSP 11a that client workstation 30d wishes to establish a communication link with Internet server 45. In response to the TAT, SSP 11a provides a query to SCP 44 that includes an authorization for establishing the communication link between client workstation 30d and Internet server 45.

Database 14 stores a list of directory numbers having authorization to access the secured service on Internet server 45, and a corresponding plurality of authentication keys for granting access to the secured service on Internet server 45. In response to the query, SCP 44 searches the list of authorized directory numbers in database 14 for the directory number of client workstation 30d during stage S76 of routine 70. Routine 70 is terminated upon a failure to detect the directory number of client workstation 30d within database 14, and the client workstation 30d is denied access to the Internet server 45.

From the preceding two exemplary illustrations of routine 70, one advantage of the present invention is the distribution of authentication keys to only authorized client workstations 30a-30c as identified in database 14. Another advantage of the present invention is the prevention of granting access of secured services of Internet server 45 to a user, authorized or unauthorized, of client workstations 30d-30f despite the user having the correct telephone number for Internet server 45.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein. For example, the present invention can be implemented with a different type of intelligent network other than an AIN, or with different or additional components of an AIN. Also, other calling sources can be incorporated into the present invention including, but not limited to, cellular telephones, wireless units, or the like, and other calling destinations other than an Internet server can be incorporated into the present invention.

We claim

1. A method of granting access to a secured service provided by a calling destination, comprising:
receiving a telephone number signal from a calling source, said telephone number signal indicating the calling destination;
identifying a directory number corresponding to said calling source;
determining if said calling source has authorization to the secured service provided by the calling destination; and
retrieving an authentication key when said calling source has authorization to the secured service.

2. The method of claim 1, further comprising:
providing said authentication key to the calling destination.

3. A computer-useable medium storing a computer program product for use in a communications network, said computer program product comprising:
computer-readable code for receiving a telephone number signal from a calling source, said telephone number signal indicating a calling destination;
computer-readable code for identifying a directory number corresponding to said calling source;
computer-readable code for determining if said calling source has authorization to a secured service provided by said calling destination; and
computer-readable code for retrieving an authentication key when said calling source has authorization to a secured service provided by said calling destination.

4. The compute-useable medium of claim 3, further comprising:
computer readable code for providing said authentication key to a server in communication with said calling destination.

5. A method for operating a communication network, comprising:
providing a trigger to a switch, said trigger indicating an attempt by a calling source to establish a communication link with a calling destination;
operating said switch to provide a query to a service control point in response to said trigger, said query including an authorization to establish said communication link between said calling source and said calling destination;
operating said service control point to retrieve an authentication key from a database in response to said query when a directory number corresponding to said calling source is stored within said database.

6. The method of claim 5, further comprising:
operating said service control point to provide said authentication key to a server in communication with said calling destination.

7. The method of claim 6, further comprising:
operating said server to provide said authentication key to said calling destination.

8. The method of claim 6, further comprising:
operating said service control point to remove said authentication key from said server.

9. A communication network, comprising:
a switch operable to receive a trigger indicating an attempt by a calling source to establish a communication link with a calling destination;
a service control point; and
a database operable to store a set of authorized directory numbers and an authentication key, wherein
said switch is further operable to provide a query to said service control point in response to said trigger, said query including an authorization to establish said communication link between said calling source and said calling destination,
said service control point is operable to retrieve said authentication key from said database in response to said query when a directory number corresponding to said calling source is listed within said set of authorized directory numbers as stored within said database.

42. The communication network of claim 9, wherein
said service control point is further operable to provide said authentication key to a server in communication with said calling destination.

11. The communication network of claim 42, wherein:
said service control point is further operable to remove said authentication key from said server after said server provide said authentication key to said calling destination.

12. A method of operating a communication network, comprising:
operating a calling source to provide a telephone number signal to a communication network, said telephone number signal representative of a calling destination;
operating said communication network to determine if a directory number corresponding to said calling source is listed within a set of authorized directory numbers stored within said communication network; and
operating said communication network to provide an authentication key to a server in communication with said calling destination when said directory number is listed within said set of authorized directory numbers.

44. The method of claim 12, further comprising:
operating said server to provide said authentication key to said calling destination.

14. The method of claim 44, further comprising:
operating said communication network to establish a communication link between said calling source and said calling destination; and
operating said calling destination to provide said authentication key to said calling source.

15. The method of claim 44, further comprising:
operating said communication network to remove said authentication key from said communication network after providing said authentication key to said server.

16. A system, comprising:
a calling source;
a calling destination;
a communication network in communication with said calling source and said calling destination; and
a server in communication with said calling destination and said communication network, wherein
said calling source is operable to provide a telephone signal to said communication network, said telephone number being representative of said calling destination,
said communication network is operable to determine if a directory number corresponding to said calling source is listed within a set of authorized directory numbers stored within said communication network, and
said communication network is further operable to provide an authentication key to said server when said directory number is listed within said set of authorized directory numbers.

17. The system of claim 16, wherein
said server is operable to provide said authentication key to said calling destination.

18. The system of claim 17, wherein
said communication network is further operable to establish a communication link between said calling source and said calling destination in response to said telephone number signal; and
said calling destination is operable to provide said authentication key through said communication link to said calling source.

19. The system of claim 16, wherein
said communication network is further operable to remove said authentication key from said communication network after providing said authentication key to said server.

45. The system of claim 16, wherein
said calling source is a client workstation;
said calling destination is an Internet server; and
said communication network includes an advanced intelligent network.
